(19) United States
(12) Patent Application Publication
(10) Pub. No.: US 2012/0065808 A1
(43) Pub. Date: Mar. 15, 2012

(54) Fan Speed Control Method and Related Computer System

(76) Inventors: Che-Jung Liu, Taipei Hsien (TW); Kuo-Chieh Yuan, Taipei Hsien (TW)

(21) Appl. No.: 12/904,146

(22) Filed: Oct. 13, 2010

(30) Foreign Application Priority Data
Sep. 15, 2010 (TW) 099131203

(51) Int. Cl. G05D 23/19

(52) U.S. Cl. 700/300

(57) ABSTRACT

A fan speed control method for a computer system is disclosed. The computer system includes a Central Processing Unit (CPU), a Voltage Regulator Module (VRM) and at least one computer fan. The VRM is disposed near the CPU, to provide electrical power required by the CPU. The method includes steps of disposing a thermal sensor near the VRM to detect an ambient temperature of the VRM; and controlling speed of the at least one computer fan according to the ambient temperature.

### BACKGROUND OF THE INVENTION

1. Field of the Invention

The present invention relates to a fan speed control method and related computer system, and more particularly, to a fan speed control method and related computer system applicable for different models of central processing units (CPUs).

2. Description of the Prior Art

A computer mainframe is substantially composed of a central processing unit (CPU), a graphic card, a power supply, a DVD-ROM drive and a hard drive. The CPU is the main computing unit of the computer, and thus in order to increase performance of the computer, the CPU usually operates at very high frequency. In such a condition, heat generated by the CPU increases, and causes the temperature thereof to rise up. However, the rising temperature compromises operations of the computer and even damages the computer, and thus heat dissipation is an important aspect in the computer. At present, the most common method of heat dissipation in the computer is using heat dissipation fins, computer fans or liquid cooling. Among the above, the computer fans can be collaboratively used with other heat dissipation methods, and cost little; hence, the computer fans are extensively adopted.

In general, heat dissipation efficiency of a computer fan is directly proportional to the rotating speed thereof, and the rotating speed is controlled via a thermal sensor or a temperature detector of the CPU. For example, a CPU manufactured by Intel has a platform environmental control interface (PECI) to read a core temperature of the CPU for a manufacturer or a user. Via the PECI, a platform control hub (PCH) or a super input/output (SIO) on a motherboard can read a digital temperature detector of the CPU directly, to acquire a core temperature of the CPU.

However, when designing heat dissipation for desktop computers, even with the same brand name, core temperatures read by temperature detectors thereof have significant differences with different models of CPUs (assuming under the same surface temperature). Consequently, in the same system, replacing a CPU requires an extra fan speed control curve, to avoid overheating in the CPU and system. The follow-up problem is to know in advance which model of the CPU the system might be equipped with, for implementing the corresponding fan speed control curve in a basic input/output system (BIOS) on the motherboard. Besides, departments of reliability analysis and quality control have to verify each and every one of the CPUs, and a related procedure is shown in FIG. 1. Such a procedure will increase the cost of verification and prolong the development window.

Therefore, it is required to find a computer fan control method for all models of CPUs, to overcome the above problems.

### SUMMARY OF THE INVENTION

It is therefore a primary objective of the present invention to provide fan speed control method for all models of CPUs and associated computer system using the same.

The present invention discloses a fan speed control method for a computer system. The computer system has a central processing unit (CPU), a voltage regulator module (VRM) disposed around the CPU, for providing power required by the CPU, and at least one fan. The fan speed control method comprises steps of disposing a thermal sensor near the VRM to detect an ambient temperature of the VRM; and controlling a fan speed of the at least one fan according to the ambient temperature detected by the thermal sensor.

The present invention further discloses a computer system, capable of controlling fan speeds of different models of central processing units (CPUs). The computer system comprises a CPU; at least one fan; a voltage regulator module (VRM), disposed around the CPU, for providing power required by the CPU; a thermal sensor, disposed near the VRM, for detecting an ambient temperature of the VRM; and a fan control unit, coupled to the thermal sensor and the at least one fan, for controlling a fan speed of the at least one fan according to the ambient temperature detected by the thermal sensor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of computer system related verification procedures according to the prior arts.

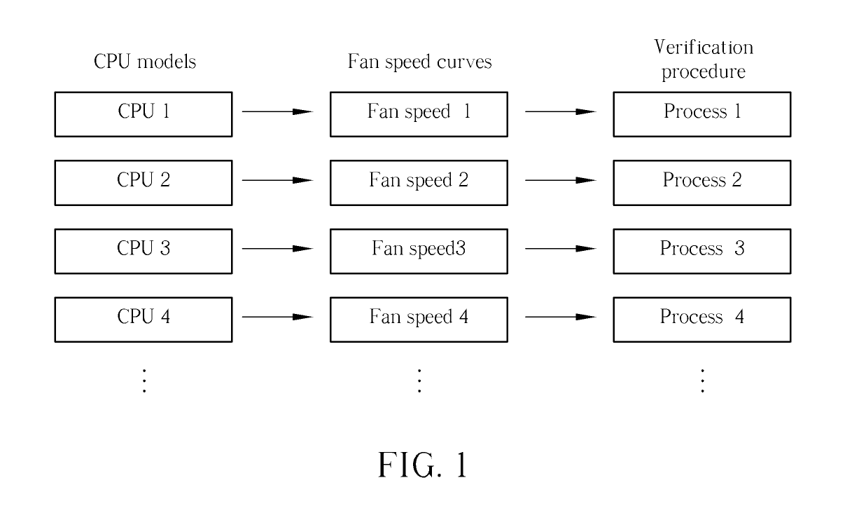

FIG. 2 illustrates a schematic diagram of a fan speed control process according to an embodiment of the present invention.

FIG. 3 illustrates a schematic diagram of computer system related verification procedures according to an embodiment of the present invention.

FIG. 4 illustrates a schematic diagram of a computer system according to an embodiment of the present invention.

FIG. 5 illustrates a schematic diagram of a thermal sensor and computer fan control unit shown in FIG. 4 according to an embodiment of the present invention.

### DETAILED DESCRIPTION

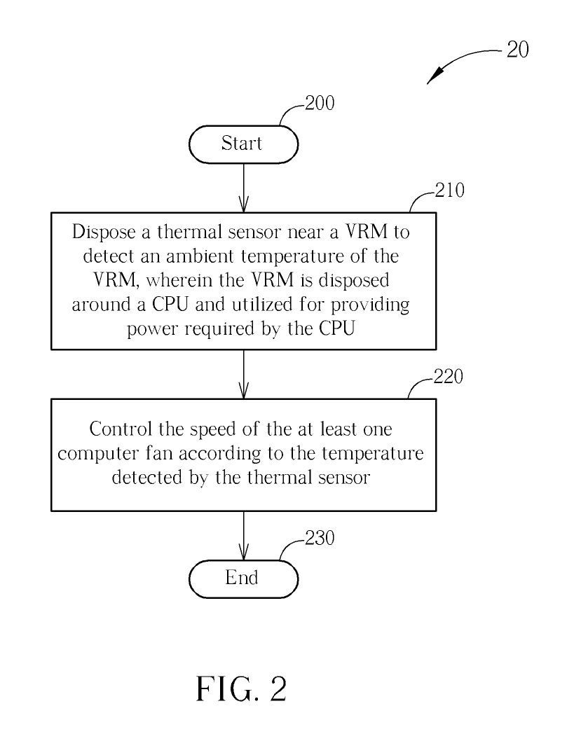

Please refer to FIG. 2, which illustrates a schematic diagram of a fan speed control process 20 according to an embodiment of the present invention. The fan speed control process 20 is utilized for controlling speed of at least one computer fan in a computer system, and includes the following steps:

Step 200: Start.

Step 210: Dispose a thermal sensor near a voltage regulator module (VRM) to detect an ambient temperature of the VRM, wherein the VRM is disposed around a CPU and utilized for providing power required by the CPU.

Step 220: Control the speed of the at least one computer fan according to the temperature detected by the thermal sensor.

Step 230: End.

According to the process 20, the present invention disposes the thermal sensor near the VRM around the CPU, to detect the ambient temperature of the VRM and control the speed of at least one computer fan according to the ambient temperature detected by the thermal sensor. As those skilled in the art recognized, the VRM is deployed around the CPU, for controlling the required CPU voltage and current. When the power consumed by the CPU increases, the power outputted by the VRM increases as well, and the temperature thereof also rises accordingly. Therefore the present invention disposes a thermal sensor or temperature detector near the VRM to monitor the temperature of the area, to use the temperature as a reference in fan speed control, so as to avoid using different fan speed curves required by different CPUs.

In addition, for different models of CPUs, as long as the rated power is the same, the VRM provides constant output power. Take a CPU with 95-watt rated power as an example, no matter what the model is, in order to reach the 95-watt rated power, the VRM must be able to provide the corresponding current to the CPU. Namely, regardless of the model, the temperature rise of the VRM is the same under the same operational power.

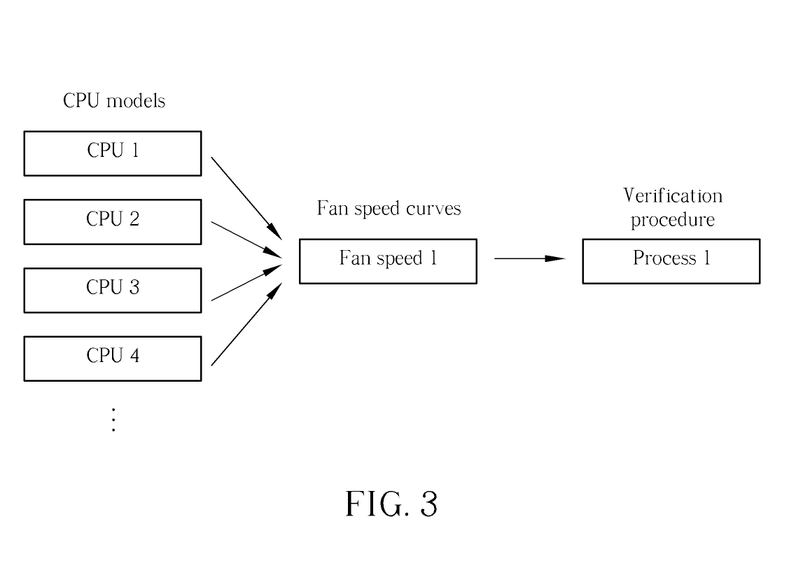

In short, the present invention performs the fan speed control by detecting the ambient temperature of the VRM, and thus just one fan speed curve is enough to meet the need of heat dissipation for the entire system and CPU. Besides, the present invention can spare a lot of follow-up reliability analyses and verification procedures from the quality control department, so as to reduce production cost efficiently, shorten the product design cycle and increase the product utility. For example, please refer to FIG. 3, which illustrates a schematic diagram of a verification procedure related to the computer system shown in FIG. 3 according to an embodiment of the present invention.

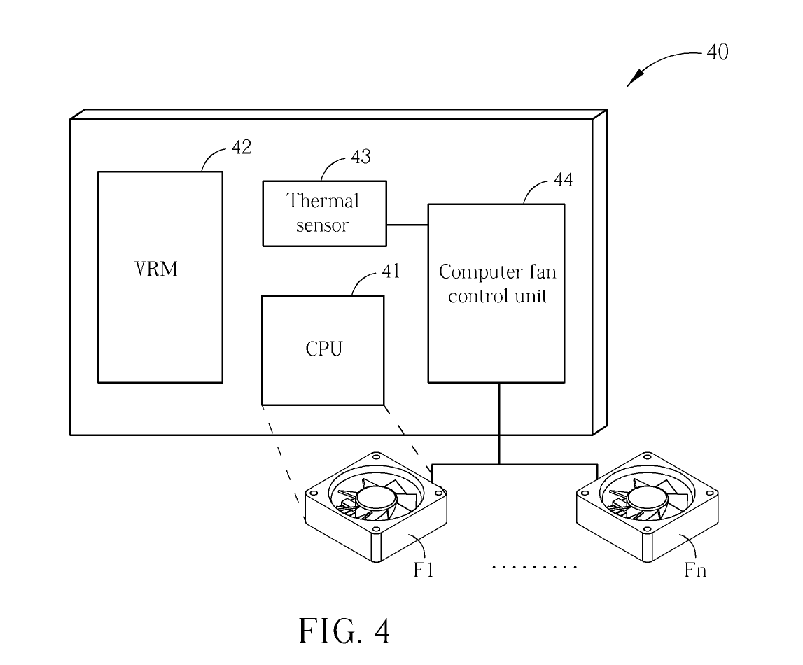

Please refer to FIG. 4, which illustrates a schematic diagram of a computer system 40 according to an embodiment of the present invention. The computer system 40 can perform fan speed control for different models of CPUs, and includes a CPU 41, a VRM 42, a thermal sensor 43, a computer fan control unit 44 and computer fans F1-Fn. The VRM 42 is disposed around the CPU 41, for converting proper operational voltage, so as to provide the power required by the CPU 41. The thermal sensor 43 is disposed near the VRM 42, for detecting an ambient temperature of the VRM 42. The computer fan control unit 44 is coupled between the thermal sensor 43 and the computer fans F1-Fn, for controlling speeds of the computer fans F1-Fn according to the ambient temperature detected by the thermal sensor 43.

As shown in FIG. 4, the VRM 42 is disposed around the CPU 41, for controlling the current required by the CPU 41. When the power consumed by the CPU 41 increases, the power outputted from the VRM 42 increases as well, and thus, the ambient temperature of the VRM 42 rises accordingly. Therefore, the present invention monitors the temperature of the area via the thermal sensor 43 disposed near the VRM 42, to use the temperature detected by the thermal sensor 43 to control the speed of the computer fans F1-Fn.

Preferably, the computer system 40 further includes a basic input/output system (BIOS) unit (not shown), coupled to the computer fan control unit 44, for storing a predetermined fan speed curve. The fan speed curve is generated according to a predetermined relation between the temperature and the fan speed. Consequently, the computer fan control unit 44 can look up for a fan speed corresponding to the present temperature according to the fan speed curve, to control the speed of the computer fans F1-Fn.

In addition, in the embodiment of the present invention, the thermal sensor 43 can be disposed around a power output terminal of the VRM 42, e.g. around output transistors, such that the thermal sensor 43 detects more realistic temperature. On the other hand, the computer fan control unit 44 can be disposed near a super input/output (SIO) chip or a platform control hub (PCH) on a motherboard, but not limited thereby.

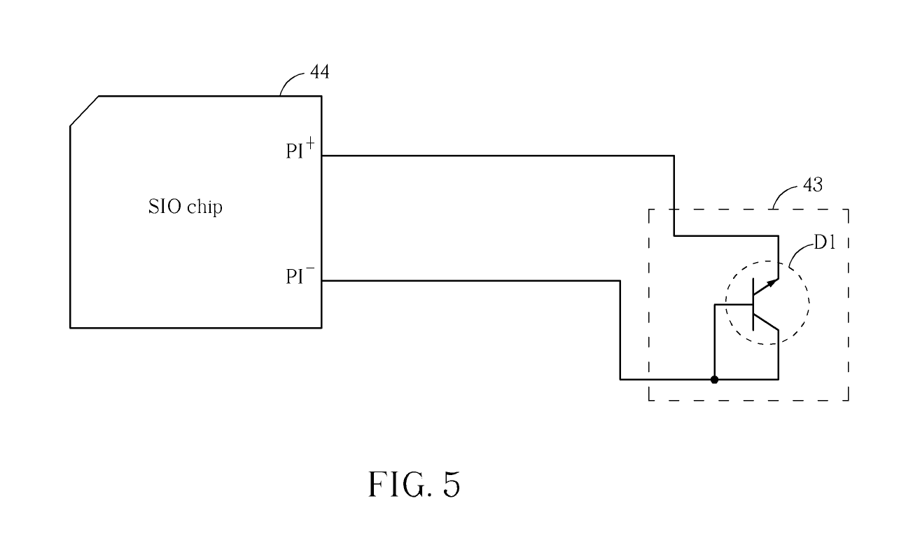

For example, please refer to FIG. 5, which illustrates a schematic diagram of the above-mentioned thermal sensor 43 and computer fan control unit 44 according to one embodiment of the present invention. In FIG. 5, the thermal sensor 43 is implemented with a thermal diode D1, while the computer fan control unit 44 is implemented with a SIO chip. As shown in FIG. 5, the thermal diode D1 is a bipolar junction transistor (BJT) with two ends connected to a pair of pins P1+ and P1− of the SIO chip respectively. As those skilled in the art recognized, a channel size of the BJT changes along with the temperature. Therefore, in the embodiment of the present invention, the SIO chip outputs current via an anode terminal of the pins P1+ and P1−, i.e. P1+, and receives current via an cathode terminal of the pins P1+ and P1−, i.e. P1−. In such a situation, the SIO chip can compute the present temperature around the thermal diode D1 according to the received current. Consequently, the present invention can take the detected temperature from thermal diode D1 as a reference for the fan speed control, so as to avoid problems raised by the requirement that different CPUs must have different fan speed curves.

Note that, in the computer system 40, the computer fans F1-Fn can be computer fans for cooling the CPU, or system fans in the computer, as long as the ambient temperature of the CPU or VRM is detected as a reference for the fan speed control.

To sum up, the present invention detects the ambient temperature of the CPU or VRM as the reference for fan speed control, and thus just one fan speed curve is enough to meet the need of heat dissipation for the entire system and the CPU. Besides, the present invention can spare a lot of follow-up reliability analyses and verification procedures from the quality control department, so as to reduce production cost efficiently, shorten the product design cycle and increase the product utility.

Those skilled in the art will readily observe that numerous modifications and alterations of the device and method may be made while retaining the teachings of the invention.

What is claimed is:

1. A fan speed control method for a computer system having a central processing unit (CPU), a voltage regulator module (VRM) disposed around the CPU, for providing power required by the CPU, and at least one fan, the fan speed control method comprising:
disposing a thermal sensor near the VRM to detect an ambient temperature of the VRM; and
controlling a fan speed of the at least one fan according to the ambient temperature detected by the thermal sensor.

2. The fan speed control method of claim 1 further comprising:
generating a fan speed curve according to a predetermined relation between temperature and fan speed.

3. The fan speed control method of claim 2, wherein the step of controlling the fan speed of the at least one fan according to the ambient temperature detected by the thermal sensor comprises:
searching a fan speed corresponding the ambient temperature according to the temperature fan speed curve; and
controlling the at least one fan to operate at the fan speed.

4. The fan speed control method of claim 1, wherein the thermal sensor is disposed near a power output terminal of the VRM.

5. The fan speed control method of claim 1, wherein the thermal sensor is a thermal diode.

6. The fan speed control method of claim 5 further comprising:
determining the ambient temperature of the VRM according to current flowing through the thermal diode.

7. The fan speed control method of claim 1, wherein the at least one fan is a system fan.

8. The fan speed control method of claim 1, wherein the at least one fan is a cooling fan of the CPU.

9. A computer system, capable of controlling fan speeds of different models of central processing units (CPUs), the computer system comprising:
a CPU;
at least one fan;
a voltage regulator module (VRM), disposed around the CPU, for providing power required by the CPU;
a thermal sensor, disposed near the VRM, for detecting an ambient temperature of the VRM; and
a fan control unit, coupled to the thermal sensor and the at least one fan, for controlling a fan speed of the at least one fan according to the ambient temperature detected by the thermal sensor.

10. The computer system of claim 9 further comprising:
a basic input/output system (BIOS) unit, coupled to the fan control unit, for storing a fan speed curve generated according to a predetermined relation of temperature and fan speed.

11. The computer system of claim 10, wherein the fan control unit searches a fan speed corresponding to the ambient temperature according to the fan speed curve, for controlling the fan speed of the at least one fan.

12. The computer system of claim 9, wherein the thermal sensor is disposed near a power output of the VRM.

13. The computer system of claim 9, wherein the thermal sensor is a thermal diode.

14. The computer system of claim 13, wherein the fan control unit determines the ambient temperature of the VRM according to current flowing through the thermal diode.

15. The computer system of claim 9, wherein the fan control unit is a super input/output (SIO) chip.

16. The computer system of claim 9, wherein the at least one fan is a system fan.

17. The computer system of claim 9, wherein the at least one fan is a cooling fan of the CPU.
